(19) United States
(12) Patent Application Publication
(10) Pub. No.: US 2007/0008387 A1
(43) Pub. Date: Jan. 11, 2007

(54) Apparatus for dispensing and printing fluids

(76) Inventors: Femia Hopwood, Winston Hills (AU); Andrew Arthur Gooley, Turramurra, NSW (AU)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 10/550,813

(22) PCT Filed: Mar. 29, 2004
(86) PCT No.: PCT/AU04/00393

§ 371 Date: Jul. 17, 2006

(30) Foreign Application Priority Data
Mar. 28, 2003 (AU) 2003901513

(51) Int. Cl. B41J 2/045

(52) U.S. Cl. 347/68

(57) ABSTRACT

A piezoelectric dispensing apparatus (10) includes a piezoelectric dispensing device (20) including a fluid reservoir (20a) and a piezoelectric dispensing tube (70). The apparatus includes a seat for receiving the device and a plunger which is shaped and configured to abut with and seal the top of the reservoir and which defines a through bore to permit the application of vacuum and or pressure to the reservoir through the bore. The plunger may be moved up and down towards and away from the seat. The fluid reservoir defines an open top and an outlet at the base of the reservoir closed by a filter. The base of the reservoir define a foot. A secondary filter assembly is attachable to the base of the reservoir. The secondary filter assembly defines a bore which is in fluid communication with the reservoir when the secondary filter assembly is attached thereto, The secondary filter assembly also defines means for removably attaching the piezoelectric dispensing tube in fluid communication with the bore. The device includes a ducks bum valve or septum for closing the outlet of the reservoir until the reservoir is attached to the removable secondary filter assembly.

### FIELD OF THE INVENTION

This invention relates to an apparatus for printing and dispensing fluids. In particular, the invention relates to the piezoelectric device for accurately dispensing small volumes of liquids into a container or onto a surface.

### BACKGROUND OF THE INVENTION

In the fields of chemistry and biological sciences, piezoelectric devices are commonly used to accurately dispense small quantities of liquids into a container or onto a surface. Present applications include dispensing reagents onto protein arrays for protein analysis, chemical printing for peptide mass finger printing, and oligonucleotide array printing. Existing piezoelectric devices can control dispensing with an accuracy of +/−100 picolitres. A typical piezoelectric device comprises a glass tube which defines a narrow through bore or capillary. The glass tube is surrounded by a ceramic collar which expands and contracts under the influence of a changing electric potential applied to the collar which causes a sonic wave in the bore. In use, a vacuum/pressure source is applied to one (non-dispensing) end of the bore. Using the well known “dip and suck” process, the dispensing end of the tube is dipped in a liquid reagent to be dispensed. A vacuum/reduced pressure is applied to suck the liquid reagent into the bore. The pressure/vacuum in the device is adjusted to retain the reagent in the tube and ensure that the meniscus at the dispensing end of the bore is flat. A changing electric potential is then applied to precisely dispense one or more drops of reagent from the dispensing end of the tube, as desired.

There are a number of problems with existing piezoelectric dispensing devices. One problem is the presence of particulate matter in the fluid being dispensed, which may block the bore of the piezoelectric device.

A further problem is that when dispensing some liquids, a slight pressure must be applied to the solution in order to produce a droplet at the orifice of the device.

Further, when dispensing liquids having a high viscosity or high visco-elasticity, the use of pressure and/or vacuum may be required.

An aim of the present invention is to address and alleviate any problems of the prior art discussed above.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

In a first broad aspect, the present invention provides a piezoelectric dispensing apparatus including:

a removable reservoir for containing liquid for dispensing from the apparatus;

a piezoelectric dispensing tube defining a bore in fluid communication with the reservoir; and

means for applying a vacuum and/or pressure to the contents of the reservoir when the reservoir is located in the apparatus.

One advantage of the present invention is that reagent can simply be loaded into the apparatus in the reservoir eliminating the existing and time consuming and occasionally messy “dip and sip” technique.

Typically the top of the reservoir will be open to allow liquids to be poured into the reservoir. Most preferably the top of the reservoir will be outwardly flared. The means for applying a vacuum and/or pressure to the contents of the reservoir when the reservoir is located in the apparatus will include a plunger which is shaped and configured to abut with and seal the top of the reservoir. The plunger preferably defines a through bore to permit the application vacuum and or pressure to the reagent vessel through the bore.

In a second broad aspect, the present invention provides a reagent vessel for use with a piezoelectric device which provides filtering within the vessel.

In particular, there is provided a reservoir assembly for containing liquid for dispensing from a piezoelectric dispensing apparatus characterised by the assembly including a primary and a secondary filter means.

The primary filter takes out most of the particles in solution. The secondary filter preferably has a pore size smaller than the primary filter and removes any particulate matter not removed by the primary filter and particulate material below the primary filter. Where the reservoir is removable from the vessel and also from the piezoelectric dispensing tube the secondary filter may be located between the reservoir and the non-dispensing end of the piezoelectric dispensing tube to prevent particulate matter collected on the underside of the reservoir from entering the tube.

In a further aspect of the present invention there is provided a piezoelectric dispensing apparatus including:

a reservoir for containing liquid for dispensing from the apparatus defining an outlet;

a piezoelectric dispensing tube defining a bore; 4

means for removable attaching the piezoelectric dispensing tube in fluid communication with the reservoir; characterised by

closure means such as a valve or septum disposed at the base of the reservoir which closes the outlet of the reservoir until the reservoir is attached to a removable secondary filter attached to a piezoelectric dispensing tube.

Preferably the base of the reservoir defines an annular foot portion on which the reservoir may be rested with the valve spaced from the surface on which the foot rests.

### BRIEF DESCRIPTION OF THE DRAWINGS

A specific embodiment of the invention will now be described by way of example only, and with reference to the accompanying drawings in which:

FIG. 1a is a schematic front view of a dispensing apparatus embodying the present invention;

FIG. 1b is a schematic side view of the dispensing apparatus of FIG. 1;

FIG. 2a is a schematic side view of a reagent vessel for use in the dispensing apparatus of FIG. 1;

FIG. 2b is a schematic front end view of a reagent vessel for use in the dispensing apparatus of FIG. 1;

FIG. 2c illustrates a secondary filter assembly;

FIG. 3 illustrates the reservoir of FIG. 2a and secondary filter assembly of FIG. 2c coupled to a piezoelectric dispensing device;

FIG. 4 illustrates the mechanism controlling the plunger position; and

FIG. 5 shows an alternative reagent vessel.

### DETAILED DESCRIPTION OF A PREFERRED EMBODIMENT

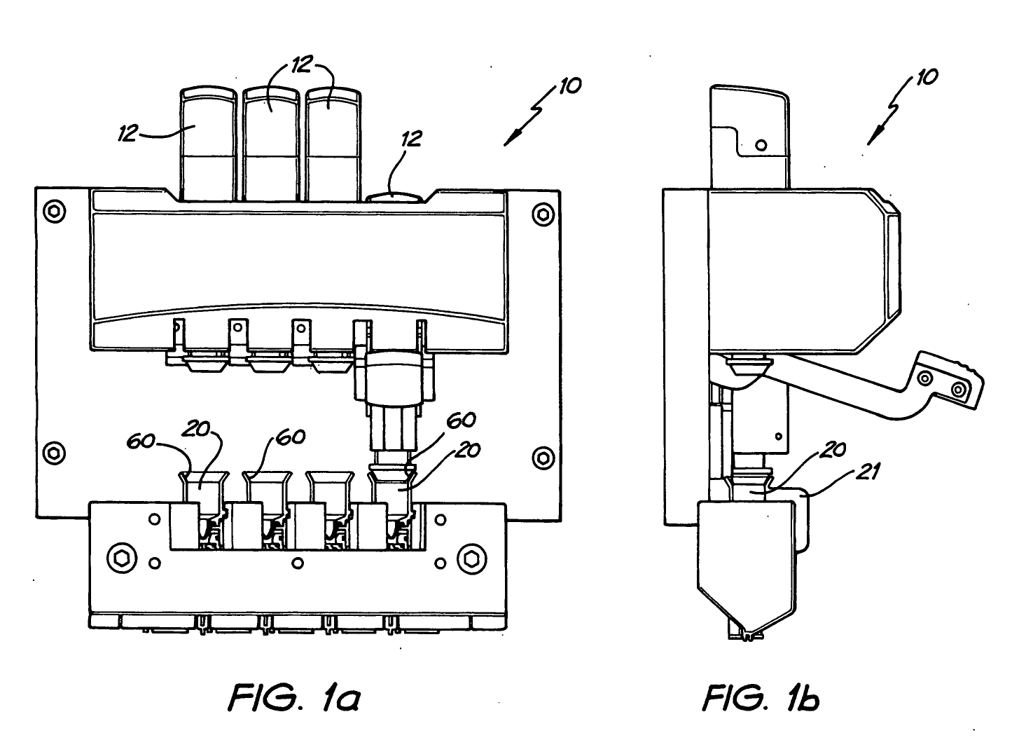

Referring to the drawings, FIG. 1 shows a schematic diagram of a piezoelectric dispensing apparatus 10. The apparatus defines an array of four plungers 12 below which are aligned a series of four seats configured to receive and support reagent vessels 20 located below the plungers. The apparatus also includes associated drive mechanisms for moving the plungers vertically up and down, towards and away from the seats. Each of the plungers defines a central through bore 14 (refer to FIG. 9) which can be connected to a source of vacuum and/or pressure.

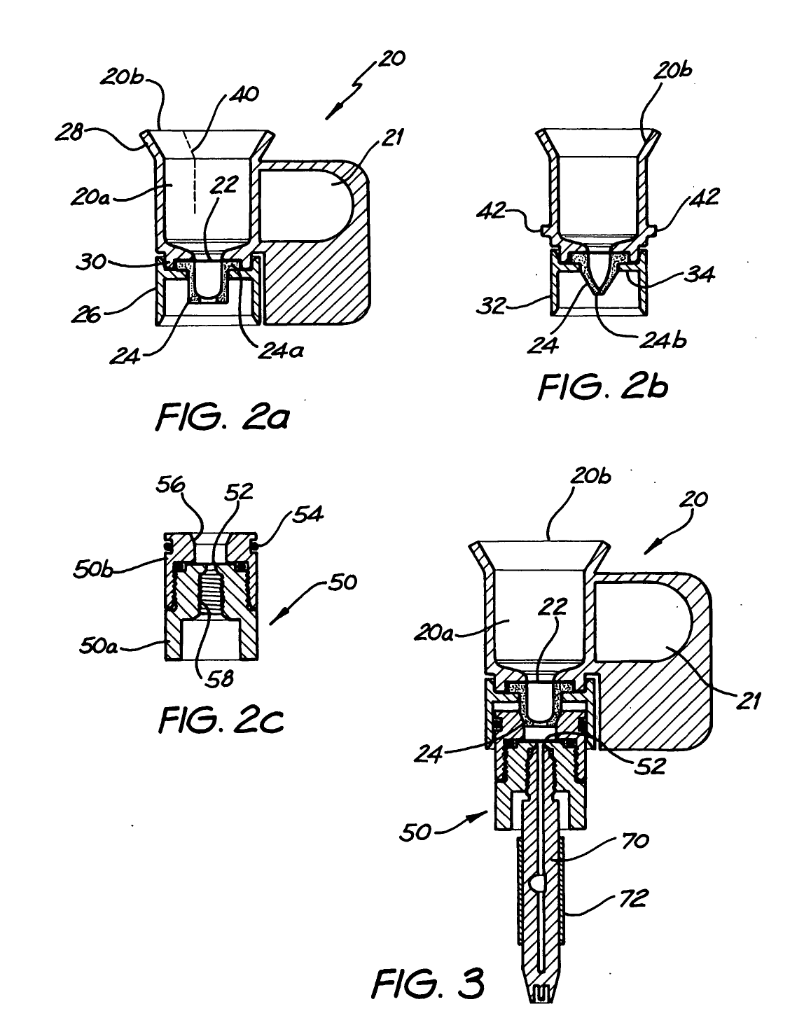

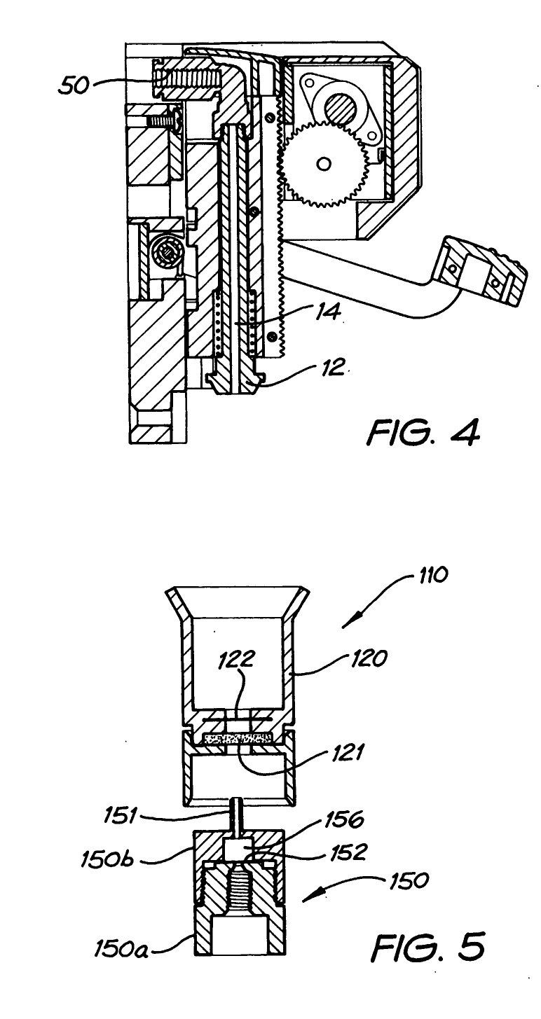

A reagent vessel 20 is shown in more detail in FIGS. 2a and 2b. The reagent vessel is made in four parts, a combined reservoir 20a and optional integral finger grip or handle 21; a filter 22; a closure means in the form of a one way PVP valve of the type colloquially known as a “ducks bum valve” 24, but which in other embodiments may be replaced by a septum or other closure means) and an annular foot portion 26 which is circular in plan view. The reservoir 20a and integral finger grip and the foot portion 26 are made of a plastics material and the parts re ultrasonically welded together capturing the valve 24 and filter 22 therebetween.

The reservoir 20a is generally rotationally symmetrical having a flared upper end 28 so that it resembles an upturned bell. The upper end 20b of the reservoir is open so that liquids may be poured directly into the reservoir.

The lower end 30 of the reservoir is closed by the valve 24. The valve comprises a rubber cup which depends from a flanged rim 24a. An elongate slit 24b which is normally closed as shown in FIGS. 2a and 2b, is defined in the lower part of the cup, but which when the sides of the valve adjacent each end of the slit are squeezed, the valve opens up for as long as that squeezing pressure is maintained. The optional finger grip 30 facilitates handling of the reagent vessel and loading of the vessel into the apparatus.

The foot portion 26 located below the reservoir, has an annular cross section, the base of which defines a circular base or foot 32. The foot portion also defines a internal flange 34 which supports the flanged rim 24a of the valve 24. The filter 22 is located above the valve 24 to capture particulates from solutions contained in the reservoir and prevent them from passing into a piezoelectric dispensing device, which in use, is located below the reservoir.

The foot portion 32 serves two functions. It allows the reagent vessel to be placed on a laboratory bench and prevents the valve 24 from touching the bench surface and opening. It also acts a sealing surface between the reagent vessel and a secondary filter holder shown in FIG. 2e.

Two rupture lines (of which one 40 is shown in FIG. 2a) may optionally be defined in the upper part of the walls of the reservoir. When the reagent vessel is removed from the apparatus 10, the rupture lines may be ruptured which would prevent the reagent vessel from being reused.

Also shown in FIG. 2b are optional bayonet guides 42 which are used to locate the reagent vessel in the apparatus 10.

The secondary filter holder 50 is shown in FIG. 2c comprises two threaded metal parts 50a, 50b that are screwed together with a secondary filter 52 clamped between the two sections. The secondary filter captures any particulates located below the primary filter 22. An O ring 54 extends around the outside of the upper end of the secondary filter assembly. In use when the secondary filter holder is inserted into the foot portion 26 of the reagent vessel the O ring provides a fluid tight seal.

A generally cylindrical outwardly flared aperture 56 is defined in the top surface of the secondary filter assembly. This aperture 56 is sufficiently shallow, and the size and shape of the aperture are such that when the secondary filter assembly is attached to the reagent vessel 20, the base of the valve 24 in the reagent vessel will push against the hole and open.

The lower part of the secondary filter assembly defines a bore in fluid communication with the aperture 56. The bore has a first diameter and a second relatively narrower diameter 58 which is threaded. A piezoelectric dispensing tube may be threaded into the narrow diameter bore 58. A standard piezoelectric dispensing tube 70 comprising a glass tube which defines a narrow through bore or capillary surrounded by a ceramic PZT material collar 72 which expands and contracts under the influence of a changing electric potential applied to the collar is used. The tube 70 secondary filter holder 50 and reagent vessel 20 are assembled together as shown in FIG. 3a. Liquid for dispensing is put in the reservoir/reagent vessel through the open upper end of the reservoir. If the reagent vessel contains liquid at the time the three components are assembled, the secondary filter should be attached to the tube 70 before being attached to the reagent vessel otherwise the valve 24 will open and leak.

FIG. 3 shows a piezoelectric device is screwed into the threaded bore of the secondary filter assembly which in turn, is attached to the reservoir 20.

With reference to FIG. 1a, the assembled reagent vessel, secondary filter assembly and piezoelectric device, are placed in a seat 60 in the dispensing apparatus 10, with the finger grip oriented to the right. The reservoir is loaded with reagent to be dispensed prior to loading in the apparatus. The bayonet guides 42 locate in grooves in the apparatus and the finger grip is then rotated in a clockwise direction to the left so that it extends to the front of the apparatus as shown in FIG. 1b, and the bayonet guides rotate along grooves in the reception means which slope towards the base of the dispensing apparatus and as well as guiding the assembly, push the assembly down.

The plunger is then lowered and the head of the plunger locates in the flared portion of the reservoir. An O ring extending around the plunger head, provides a seal and locks the reagent vessel into the dispensing apparatus.

As illustrated in FIG. 1a, the apparatus has the capacity to receive four reagent vessels.

As shown in FIG. 5, each plunger defines a central through bore 14. The bore is linked to a means for applying a vacuum, or pressure through the bore to the reservoir 20 of the reagent vessel. The piezoelectric devices are primed by applying pressure to the liquid in the reagent vessel through the bore of the plunger which pushes the liquid through the primary filter 22 and through the secondary filter 52. Piezoelectric electric devices are operated for droplet dispensing under low vacuum conditions to control the fluid meniscus at the orifice of the piezoelectric device. A pneumatics control shown schematically at 50 corrects imbalances in surface tension of the fluid, capillary action or hydrostatic pressure that prevents solution from being dispensed from the piezoelectric device. Droplets are dispensed from the piezoelectric device by applying an electric pulse or wave to the device which generate an acoustic wave in the solution in the glass capillary resulting in a droplet being dispensed from the device orifice. These techniques are well known in the field of glass capillary piezoelectric dispensing.

On completion of dispensing, the reagent vessel may be released from the apparatus by means of a small downward motion of the plunger initiated by the pressing of a release button. The additional pressure on the flared portion causes the breaking of the rupture lines 40 preventing re-use of the reagent vessel. The plunger then rises as shown in FIG. 8 and returns to the top of the apparatus. The used reagent vessel can be removed and discarded. Once the reagent vessel is released from the apparatus, the valve at the bottom of the reagent vessel, will close preventing any unused solution from leaking out of the reagent vessel.

Alternatively, the plunger may simply rise, leaving the vessel intact.

The operation of the plunger is illustrated in more detail in FIG. 9. At rest, the plunger position is controlled by an indexing cam mechanism which comprises a star shape control element and a smaller index element. The index element is acted on a sprung detent which is shaped to give the cam a tendency to return to the indexed position. The cam and detent mechanism are mounted on a pivoting arm which is held in a default position by a spring.

The plunger is also held in its rest position by a spring. When the plunger is depressed, a drive pin attached to it travels downwards and engaging a lobe of the cam causes it to turn. As the plunger is further depressed, the cam turns sufficiently to allow the detent to engage the next index position. At this point, the cam ceases to be driven by the plunger, rather it is the force applied by the detent mechanism that causes it to continue turning. This rotation means that the next lobe of the cam to bear on the drive pin and depress the plunger further. This action is sufficient to complete the loading of the reaction vessel and is arranged so that with the vessel in place, some force is still exerted by the detent on the cam. This ensure that the cam is able to apply sufficient pressure to the plunger to maintain a seal with the reagent vessel. This condition is maintained until the release mechanism is actuated. The release lever acts on the pivoting arm depressing it causing the cam and arm assembly to slide aside releasing the drive pin and allowing the plunger to return to its rest position. The pivoting of the arm is arranged so that on route to release the plunger, is forced further downwards providing the extra travel required to rupture the vessel.

FIG. 10 illustrates a second embodiment of a reagent vessel 110 including an open topped reservoir 120 similar to reservoir 20 of the first reagent vessel. However in the reagent vessel 110 the closure means closing the base of the reservoir is a septum 121 disposed below the filter 122 rather than a valve. There is no integral finger grip.

The secondary filter holder 150, is similar to the filter holder 50 of the first embodiment. It comprises two threaded metal parts 150a, 150b that are screwed together with a secondary filter 152 clamped between the two sections. The secondary filter captures any particulates located below the primary filter 22. Part 150a to which the piezoelectric tube is attached is identical to part 50a. Part 150b defines two differences from part 50b. There is no external O-ring 54 and the secondary filter holder 150b defines an upwardly protruding hollow needle 151, of a length which pierces the septum 121 when the secondary filter assembly is screwed to the base of the reservoir, but does not reach or pierce the filter 122. This obviates the need to have a valve at the base of the reservoir and reduces manufacturing costs. The hollow needle is in fluid communication with a chamber 156.

The lower part 150a of the secondary filter assembly 150 defines a bore 158 in fluid communication with the chamber 156 via the secondary filter 152. The bore 158 has a first diameter and a second relatively narrower diameter 158 which is threaded. A piezoelectric dispensing tube may be threaded into the narrow diameter bore 58. A standard piezoelectric dispensing tube 70 as shown in FIG. 3a can be used. The tube 70 secondary filter holder 150 and reagent vessel 110 are assembled together in the same way as the first embodiment shown in FIG. 3a. Liquid for dispensing is put in the reservoir/reagent vessel 120 through the open upper end of the reservoir. If the reagent vessel contains liquid at the time the three components are assembled, the secondary filter holder 150 should be attached to the tube 70 before being attached to the reagent vessel otherwise the valve 24 will open and leak.

With reference to FIG. 1a, the assembled reagent vessel, secondary filter assembly and piezoelectric device, are placed in a seat 60 in the dispensing apparatus 10 and the device is used in the same way as the first embodiment, as described above.

There may be an array of greater or fewer than four piezoelectric dispensing devices in the apparatus. The use of micro-arrayed solid state piezoelectric ceramic may permit closely arrayed multiple channels and up to possibly one hundred solution streams.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A piezoelectric dispensing apparatus comprising:
a removable reservoir for containing liquid for dispensing from the apparatus;
a piezoelectric dispensing tube defining a bore in fluid communication with the reservoir; and
means for applying a vacuum and/or pressure to the contents of the reservoir when the reservoir is located in the apparatus.

2. A piezoelectric dispensing apparatus as claimed in claim 1 wherein the reservoir defines an open top to allow liquids to be poured into the reservoir.

3. A piezoelectric dispensing apparatus as claimed in claim 2 wherein the top of the reservoir is flared outwardly.

4. A piezoelectric dispensing apparatus as claimed in claim 3 wherein the means for applying a vacuum and/or pressure to the contents of the reservoir when the reservoir is located in the apparatus comprises a plunger shaped and configured to abut with and seal the top of the reservoir.

5. A piezoelectric dispensing apparatus as claimed in claim 4 wherein the plunger comprises a through bore to permit the application of vacuum or pressure to the reagent vessel through the bore.

6. A piezoelectric dispensing apparatus as claimed in claim 4 comprising a seat for receiving the removable reservoir and means for moving the plunger up and down towards and away from the seat.

7. A reservoir assembly for containing liquid for dispensing from a piezoelectric dispensing device, the piezoelectric dispensing device comprising a dispensing end and a non-dispensing end, wherein the assembly comprises a first filter means and a second filter means.

8. A reservoir assembly as claimed in claim 7 wherein the second filter has a pore size smaller than the pore size of the first filter

9. A reservoir assembly as claimed in claim 7 wherein the second filter is located between the reservoir and the non-dispensing end of the piezoelectric dispensing tube to prevent particulate matter collected on the underside of the reservoir from entering the tube.

10. A piezoelectric dispensing device comprising:
a reservoir for containing liquid to be dispensed from the device, the reservoir comprising an open top and an outlet at a base of the reservoir;
a filter for filtering liquids passing through the outlet;
a piezoelectric dispensing tube defining a bore;
means for removably attaching the piezoelectric dispensing tube in fluid communication with the reservoir the attaching means comprising a closure means disposed at the base of the reservoir for closing the outlet of the reservoir when the reservoir is not attached to the piezoelectric dispensing tube.

11. A piezoelectric dispensing device as claimed in claim 10 further comprising an annular foot portion on which the base of the reservoir is positionable wherein the He closure means is spaced from the surface on which the foot rests.

12. A piezoelectric dispensing device as claimed in claim 11 further comprising a handle attached to the reservoir.

13. A piezoelectric dispensing device as claimed in claim 10 wherein the closure means is a septum.

14. A piezoelectric dispensing device as claimed in claim 10 wherein the closure means is a valve.

15. A piezoelectric dispensing device including:
a reservoir for containing liquid to be dispensed from the device and comprising an open top and an outlet at a base of the reservoir;
a filter extending across the outlet of the reservoir;
a secondary filter assembly removably attachable to the base of the reservoir, the secondary filter assembly defining a bore in fluid communication with the reservoir when the secondary filter assembly is attached thereto, the secondary filter assembly comprising means for removably attaching a piezoelectric dispensing tube in fluid communication with the bore; and
means for closing the outlet of the reservoir when the removable secondary filter assembly is not attached to the reservoir.

16. A piezoelectric dispensing device as claimed in claim 15 further comprising a piezoelectric dispensing tube defining a bore attached to the outlet of the secondary filter assembly.

17. A piezoelectric dispensing device as claimed in claim 15 wherein the means for closing the outlet of the reservoir is a valve.

18. A piezoelectric dispensing device as claimed in claim 15 wherein the means for closing the outlet of the reservoir are a septum and wherein a hollow needle for piercing the septum projects from the secondary filter assembly.

19. A piezoelectric dispensing apparatus comprising
a reservoir for containing liquid to be dispensed from the device, the reservoir comprising an open top and an outlet at a base of the reservoir;
a filter for filtering liquids passing through the outlet;
a piezoelectric dispensing tube defining a bore and comprising means for removably attaching the piezoelectric dispensing tube in fluid communication with the reservoir; and
a closure means disposed at the base of the reservoir for closing the outlet of the reservoir when a removable secondary filter is not attached to the reservoir;
further including an apparatus defining a seat for receiving the removable reservoir in the apparatus, means for applying a vacuum or pressure to the contents of the reservoir said applying means comprising a plunger shaped and configured to abut with and seal the open top of the reservoir and which defines a through bore to permit the application of vacuum or pressure to the reservoir through the bore, the plunger being movable relative to the seat.

20. A method of dispensing fluid from a piezoelectric tube assembly, the assembly comprising a piezoelectric tube having a dispensing end and a non dispensing end, the method comprising dispensing fluid from a reservoir disposed in fluid communication with the non-dispensing end of the piezoelectric tube.
